(19) United States
(12) Patent Application Publication
(10) Pub. No.: US 2026/0171036 A1
(43) Pub. Date: Jun. 18, 2026

(54) METHOD AND DEVICE FOR PERFORMING A BACKLIGHT DEMONSTRATION ON A TELEVISION, AND RELATED DEVICES

(71) Applicant: Amlogic (Shenzhen) Co., Ltd., Shen Zhen (CN)

(72) Inventors: Ren Yu, Shen Zhen (CN); Xiaofan He, Shen Zhen (CN); Shoufu Zhao, Shen Zhen (CN); Wei Yu, Shen Zhen (CN); Lichao Xu, Shen Zhen (CN); Hao Fu, Shen Zhen (CN); Chong Wang, Shen Zhen (CN)

(21) Appl. No.: 19/413,934

(22) Filed: Dec. 9, 2025

(30) Foreign Application Priority Data
Dec. 13, 2024 (CN) 202411854298.2

(51) Int. Cl. G09G 3/34; G09G 3/20

(52) U.S. Cl. CPC G09G 3/3413; G09G 3/2007; G09G 3/3426; G09G 2310/08; G09G 2320/0626; G09G 2320/0666; G09G 2354/00; G09G 2360/16

(57) ABSTRACT

A method and device for performing a backlight demonstration on a television, and related devices, wherein method for performing a backlight demonstration on a television includes: acquiring a backlight demonstration instruction from a user; and utilizing a timing control circuit and a local dimming circuit in a system-on-chip of a television to generate corresponding backlight demonstration control data to control a display screen and a backlight array of the television to perform the backlight demonstration, when the backlight demonstration instruction from the user is acquired. The technical solution of the present disclosure can reduce the cost of backlight demonstration on a television.

### CROSS-REFERENCE TO RELATED APPLICATIONS

This application claims priority to Chinese Patent Application No. 202411854298.2, filed on Dec. 13, 2024, the entire disclosure of which is incorporated herein by reference.

### TECHNICAL FIELD

The present disclosure relates to the technical field of television backlight control, and in particular to a method and device for performing a backlight demonstration on a television, and related devices.

### BACKGROUND

Dynamic backlight control technology for televisions, which can improve dynamic contrast and depth in images, has gradually become a mainstream area of research and application in the LCD TV industry. With the continuous development and in-depth research of light-emitting diode (LED) technology, LEDs have become a mainstream backlight source for LCD TVs.

Currently, TV salespeople often use backlight demonstrations to allow users to intuitively experience the effects of backlight control. However, existing backlight demonstration methods are costly.

### SUMMARY

The problem solved by the embodiments of the present disclosure is to provide a method and device for performing a backlight demonstration on a television, and related devices, which can reduce the cost of television backlight demonstration.

To solve the above problem, a method for performing a backlight demonstration on a television is provided in the embodiments of the present disclosure, comprising:
acquiring a backlight demonstration instruction from a user; and
utilizing a timing control circuit and a local dimming circuit in a system-on-chip of a television to generate corresponding backlight demonstration control data to control a display screen and a backlight array of the television to perform the backlight demonstration, when the backlight demonstration instruction from the user is acquired.

Optionally, utilizing the timing control circuit and the local dimming circuit in the system-on-chip of the television to generate corresponding backlight demonstration control data to control the display screen and the backlight array of the television to perform the backlight demonstration comprises:
utilizing the timing control circuit to generate corresponding demonstration drive data, and driving the display screen to display a corresponding full-screen demonstration image based on the demonstration drive data;
utilizing the local dimming circuit to generate corresponding first backlight control data based on the full-screen demonstration image, when the full-screen demonstration image is displayed on the display screen; and
utilizing a backlight control chip to control the backlight array of the television based on the first backlight control data.

Optionally, the full-screen demonstration image is a spliced image of a video demonstration image located in a non-backlight control area of the display screen and a white demonstration image located in a backlight control area of the display screen.

Optionally, utilizing the timing control circuit to generate corresponding demonstration drive data, and driving the display screen to display the corresponding full-screen demonstration image based on the demonstration drive data comprises:
setting grayscale data in an automatic color correction table to corresponding maximum grayscale values based on a preset demonstration template file;
setting effective coordinates of the video demonstration image in a preset template register based on information of the non-backlight control area; and
driving the display screen to display the full-screen demonstration image based on the grayscale data in the automatic color correction table and the effective coordinates of the video demonstration image in the template register.

Optionally, utilizing the local dimming circuit to generate corresponding first backlight control data based on the full-screen demonstration image comprises:
acquiring local dimming data for a non-backlight control area of the backlight array, wherein the local dimming data for the non-backlight control area of the backlight array is the local dimming data for the video demonstration image;
mapping the local dimming data for the non-backlight control area of the backlight array to a backlight control area of the backlight array according to a preset mapping relationship to acquire the local dimming data for the backlight control area of the backlight array; and
setting the local dimming data for the non-backlight control area of the backlight array to a preset maximum dimming value, after mapping the local dimming data for the non-backlight control area of the backlight array to the backlight control area of the backlight array according to the preset mapping relationship;
wherein the local dimming data for the non-backlight control area of the backlight array and the local dimming data for the backlight control area of the backlight array are both the maximum dimming value, constituting the first backlight control data.

Optionally, the local dimming circuit uses a preset serial peripheral interface to transmit the first backlight control data to the backlight control chip, so that the backlight control chip controls the backlight array of the television according to the first backlight control data.

Optionally, acquiring the backlight demonstration instruction from the user comprises:
acquiring the backlight demonstration instruction from the user using a preset user interface; after acquiring the backlight demonstration instruction from the user, and before utilizing the timing control circuit to generate corresponding demonstration drive data, and driving the display screen to display the corresponding full-screen demonstration image based on the demonstration drive data, further comprising: issuing the backlight demonstration instruction using the user interface; and invoking a backlight demonstration interface in a television server process using a television client process based on the backlight demonstration instruction to send a first backlight demonstration notification, causing the timing control circuit to generate corresponding demonstration drive data based on the first backlight demonstration notification, and driving the display screen to display the corresponding full-screen demonstration image based on the demonstration drive data;
after utilizing the timing control circuit to generate corresponding demonstration drive data, and driving the display screen to display the corresponding full-screen demonstration image based on the demonstration drive data, and before utilizing the local dimming circuit to generate corresponding first backlight control data based on the full-screen demonstration image, further comprising: sending a second backlight demonstration notification to the local dimming circuit using the timing control circuit, causing the local dimming circuit to generate corresponding first backlight control data based on the full-screen demonstration image upon receiving the second backlight demonstration notification;
after receiving the second backlight demonstration notification, further comprising: returning a corresponding first return value to the user interface through a television server process and a television client process using the local dimming circuit, wherein the first return value is used to indicate that the backlight demonstration instruction is successfully issued.

Optionally, the method further comprises:
acquiring a backlight demonstration cancellation instruction from the user; and
utilizing the timing control circuit and the local dimming circuit to generate corresponding normal playback drive data to control the display screen and the backlight array of the television for normal playback, when the backlight demonstration cancel instruction from the user is acquired.

Optionally, utilizing the timing control circuit and the local dimming circuit to generate corresponding normal playback drive data to control the display screen and the backlight array of the television for normal playback comprises:
utilizing the timing control circuit to generate corresponding full-screen normal playback drive data, and driving the display screen to display the corresponding full-screen normal playback image based on the full-screen normal playback drive data;
utilizing the local dimming circuit to generate corresponding second backlight control data based on the full-screen normal playback image, when the full-screen normal playback image is displayed on the display screen;
utilizing the backlight control chip to control the backlight array of the television based on the second backlight control data.

Optionally, utilizing the timing control circuit to generate corresponding full-screen normal playback drive data, and driving the display screen to display the corresponding full-screen normal playback image based on the full-screen normal playback drive data comprises:
refreshing the grayscale data in the automatic color correction table based on the full-screen normal playback image, so that the grayscale data in the automatic color correction table are corresponding grayscale values, and deleting the effective coordinates of the video demonstration image set in the preset template register; and
driving the display screen to display the full-screen normal playback image based on the grayscale data in the automatic color correction table.

Optionally, utilizing the local dimming circuit to generate corresponding second backlight control data based on the full-screen normal playback image comprises:
setting the local dimming data of the backlight array to corresponding dimming values based on the full-screen normal playback image using the local dimming circuit.

Optionally, acquiring the backlight demonstration cancellation instruction from the user comprises: acquiring the backlight demonstration cancellation instruction from the user using the preset user interface;
after acquiring the backlight demonstration cancellation instruction from the user, and before utilizing the timing control circuit to generate corresponding full-screen normal playback drive data, and driving the display screen to display the corresponding full-screen normal playback image based on the full-screen normal playback drive data, further comprising: issuing the backlight demonstration cancellation instruction using the user interface; and invoking the backlight demonstration interface in the television server process using the television client process based on the backlight demonstration cancellation instruction to send a first backlight demonstration cancellation notification, causing the timing control circuit to generate corresponding full-screen normal playback drive data based on the first backlight demonstration cancellation notification, and driving the display screen to display the corresponding full-screen normal playback image based on the full-screen normal playback drive data;
after utilizing the timing control circuit to generate corresponding full-screen normal playback drive data, and driving the display screen to display the corresponding full-screen normal playback image based on the full-screen normal playback drive data, and before utilizing the local dimming circuit to generate corresponding second backlight control data based on the full-screen normal playback image, further comprising: sending a second backlight demonstration cancellation notification to the local dimming circuit using the timing control circuit, causing the local dimming circuit to generate corresponding second backlight control data based on the full-screen normal playback image upon receiving the second backlight demonstration cancellation notification;
after receiving the second backlight demonstration cancellation notification, further comprising: returning a corresponding second return value to the user interface through the television server process and the television client process using the local dimming circuit, wherein the second return value is used to indicate that the backlight demonstration cancellation instruction is successfully issued.

Correspondingly, a device for performing a backlight demonstration on a television is provided in the embodiments of the present disclosure, comprising:
a first acquisition circuit, configured to acquire a backlight demonstration instruction from a user;
a backlight demonstration circuit, configured to utilize a timing control circuit and a local dimming circuit in a system-on-chip of a television to generate corresponding backlight demonstration control data to control a display screen and a backlight array of the television to perform the backlight demonstration, when the backlight demonstration instruction from the user is acquired.

Correspondingly, a computer program product is further provided in the embodiments of the present disclosure, comprising a computer program/instruction, wherein when executed by a processor, the computer program/instruction implements any one of the methods for performing a backlight demonstration on a television above.

Correspondingly, a device is further provided in the embodiments of the present disclosure, comprising at least one memory and at least one processor, wherein the memory stores one or more computer instructions, wherein the one or more computer instructions are executed by the processor to implement any one of the methods for performing a backlight demonstration on a television above.

Correspondingly, a storage medium is further provided in the embodiments of the present disclosure, having one or more computer instructions stored thereon, wherein the one or more computer instructions are used to implement any one of the methods for performing a backlight demonstration on a television above.

Compared with the prior art, the technical solutions in the embodiments of the present disclosure have the advantages as follows:

The method for performing a backlight demonstration on a television, as provided in the embodiments of the present disclosure, comprises: acquiring a backlight demonstration instruction from a user; utilizing a timing control circuit and a local dimming circuit in a system-on-chip of a television to generate corresponding backlight demonstration control data to control a display screen and a backlight array of the television to perform the backlight demonstration, when the backlight demonstration instruction from the user is acquired.

The method for performing a backlight demonstration on a television, as provided in the embodiments of the present disclosure, utilizes a timing control circuit and a local dimming circuit in a system-on-chip of a television to generate corresponding backlight demonstration control data to control a display screen and a backlight array of the television to perform the backlight demonstration, when the backlight demonstration instruction from the user is acquired. Compared with the solution of setting up special hardware for backlight demonstration, this method is beneficial to reducing the cost of backlight demonstration on a television.

### BRIEF DESCRIPTION OF THE DRAWINGS

FIG. 1 shows a flow diagram of an embodiment of method for performing a backlight demonstration on a television according to the present disclosure;

FIG. 2 shows a flow diagram of another embodiment of method for performing a backlight demonstration on a television according to the present disclosure;

FIG. 3 shows a schematic diagram of an embodiment of a backlight array of a television according to the present disclosure;

FIG. 4 shows a schematic diagram of the process of switching from a backlight demonstration mode to a normal playback mode in another embodiment of method for performing a backlight demonstration on a television according to the present disclosure;

FIG. 5 shows a schematic structural diagram of an embodiment of device for performing a backlight demonstration on a television according to the present disclosure;

FIG. 6 shows a schematic structural diagram of an optional hardware of the device according to the present disclosure.

### DETAILED DESCRIPTION

As can be seen from the background, existing backlight demonstration methods are costly.

In order to solve the technical problem, a method for performing a backlight demonstration on a television is provided in the embodiments of the present disclosure.

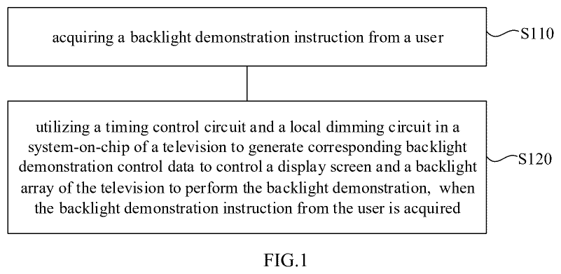

FIG. 1 shows a flow diagram of an embodiment of method for performing a backlight demonstration on a television according to the present disclosure. Referring to FIG. 1, a method for performing a backlight demonstration on a television may include the following steps:

Step S110: acquiring a backlight demonstration instruction from a user;

Step S120: utilizing a timing control circuit and a local dimming circuit in a system-on-chip of a television to generate corresponding backlight demonstration control data to control a display screen and a backlight array of the television to perform the backlight demonstration, when the backlight demonstration instruction from the user is acquired.

The method for performing a backlight demonstration on a television, as provided in the embodiments of the present disclosure, utilizes a timing control circuit and a local dimming circuit in a system-on-chip of a television to generate corresponding backlight demonstration control data to control a display screen and a backlight array of the television to perform the backlight demonstration, when the backlight demonstration instruction from the user is acquired. Compared with the solution of setting up special hardware for backlight demonstration, this method is beneficial to reducing the cost of backlight demonstration on a television.

To make the above objectives, features, and advantages in the embodiments of the present disclosure more apparent and easier to understand, specific embodiments of the present disclosure are described in detail below with reference to the accompanying drawings.

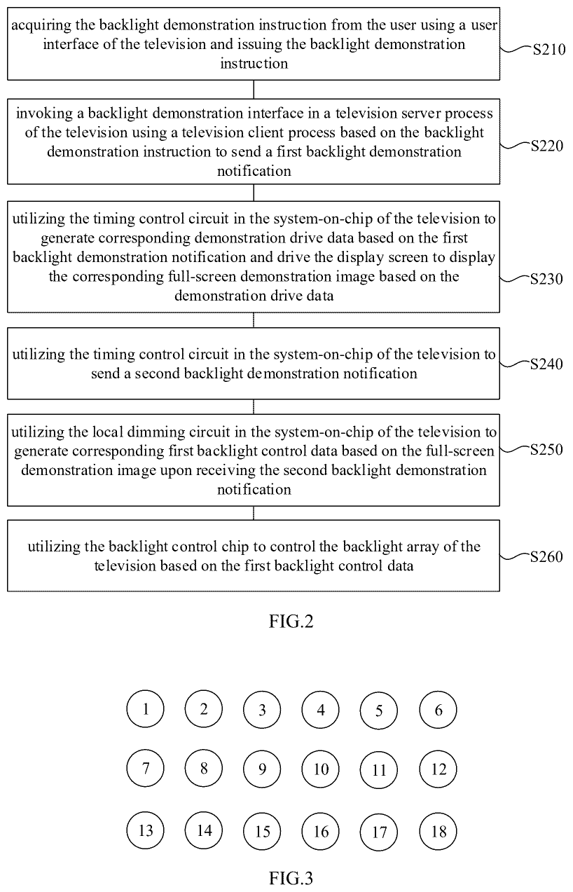

FIG. 2 shows a flow diagram of another embodiment of method for performing a backlight demonstration on a television according to the present disclosure. Referring to FIG. 2, a method for performing a backlight demonstration on a television may include the following steps:

Step S210: acquiring the backlight demonstration instruction from the user using a user interface of the television and issuing the backlight demonstration instruction;

Step S220: invoking a backlight demonstration interface in a television server process of the television using a television client process based on the backlight demonstration instruction to send a first backlight demonstration notification;

Step S230: utilizing the timing control circuit in the system-on-chip of the television to generate corresponding demonstration drive data based on the first backlight demonstration notification and drive the display screen to display the corresponding full-screen demonstration image based on the demonstration drive data;

Step S240: utilizing the timing control circuit in the system-on-chip of the television to send a second backlight demonstration notification;

Step S250: utilizing the local dimming circuit in the system-on-chip of the television to generate corresponding first backlight control data based on the full-screen demonstration image upon receiving the second backlight demonstration notification;

Step S260: utilizing the backlight control chip to control the backlight array of the television based on the first backlight control data.

Continuing with reference to FIG. 2, step S210 is performed to acquire the backlight demonstration instruction from the user using a user interface of the television and issuing the backlight demonstration instruction.

Acquiring the backlight demonstration instruction from the user using a user interface of the television and issuing the backlight demonstration instruction provides a basis for invoking a backlight demonstration interface in a television server process of the television using a television client process based on the backlight demonstration instruction to send a first backlight demonstration notification.

In some embodiments, the step of acquiring the backlight demonstration instruction from the user using a user interface of the television includes receiving the backlight demonstration instruction input by the user via a user interface (UI).

In some embodiments, the backlight demonstration instruction from the user can also be acquired through other means. For example, a corresponding demonstration button can be set, and the backlight demonstration instruction from the user can be received when the demonstration button is detected to be pressed.

In some embodiments, when the backlight demonstration instruction from the user is acquired through the user interface, the user interface forwards the backlight demonstration instruction to the TV client process of the television, so that the TV client process can acquire the backlight demonstration instruction.

Referring to FIG. 2, step S220 is performed to invoke a backlight demonstration interface in a TV server process of the television using a television client process based on the backlight demonstration instruction to send a first backlight demonstration notification.

Invoking a backlight demonstration interface in a television server process of the television using a television client process based on the backlight demonstration instruction to send a first backlight demonstration notification provides a basis for subsequently utilizing the timing control circuit in the system-on-chip of the television to generate corresponding demonstration drive data based on the first backlight demonstration notification and drive the display screen to display the corresponding full-screen demonstration image based on the demonstration drive data.

In some embodiments, the step of invoking a backlight demonstration interface in a television server process of the television using a television client process based on the backlight demonstration instruction to send a first backlight demonstration notification includes: using the TV client process to establish a connection with the TV server process; and after the connection is established, using the TV client process to invoke the backlight demonstration interface in the TV server process to send the first backlight demonstration notification.

In some embodiments, the TV client process establishes a connection with the TV server process using a binder mechanism to enable inter-process communication between the TV client process and the TV server process.

In some embodiments, the step of invoking a backlight demonstration interface in a television server process using a television client process to send a first backlight demonstration notification includes: using the TV client process to send the backlight demonstration instruction to the TV server process; and, upon receiving the backlight demonstration instruction, using the TV server to invoke the backlight demonstration interface to send the first backlight demonstration notification via input/output control (IO control).

In some embodiments, the first backlight demonstration notification is a flag command. Specifically, a corresponding flag variable is set to a corresponding value to indicate that a backlight demonstration operation is being performed.

Referring to FIG. 2, step S230 is performed to utilize the timing control circuit in the system-on-chip (SoC) of the television to generate corresponding demonstration drive data based on the first backlight demonstration notification and drive the display screen to display the corresponding full-screen demonstration image based on the demonstration drive data.

Utilizing the timing control circuit in the system-on-chip of the television to generate corresponding demonstration drive data based on the first backlight demonstration notification and drive the display screen to display the corresponding full-screen demonstration image based on the demonstration drive data provides a basis for subsequently utilizing the timing control circuit in the system-on-chip of the television to send a second backlight demonstration notification.

In some embodiments, the full-screen demonstration image is a spliced image of a video demonstration image located in a non-backlight control area of the display screen and a white demonstration image located in a backlight control area of the display screen.

Accordingly, the steps of utilizing the timing control circuit in the system-on-chip of the television to generate corresponding demonstration drive data based on the first backlight demonstration notification and drive the display screen to display the corresponding full-screen demonstration image based on the demonstration drive data include: setting grayscale data in an automatic color correction table to corresponding maximum grayscale values based on a preset demonstration template file; setting effective coordinates of the video demonstration image in a preset template register based on information of the non-backlight control area; and driving the display screen to display the full-screen demonstration image based on the grayscale data in the automatic color correction table and the effective coordinates of the video demonstration image in the template register.

In some embodiments, the timing control driver in the timing control circuit sets the grayscale data in the automatic color correction table in the automatic color correction circuit to the maximum grayscale values based on the demonstration template file.

The maximum grayscale value can be set according to actual needs. For example, if the grayscale data in the automatic color correction table is 1024-level RGB grayscale data, the maximum grayscale value is 4096.

The timing control driver in the timing control circuit is used to set the grayscale data in the automatic color correction table in the automatic color correction circuit to a preset maximum grayscale value according to a preset demonstration sample file. When the grayscale data in the automatic color correction table is subsequently used to drive the display screen, the display screen displays the white demonstration image in full screen.

Accordingly, in order to limit the white demonstration image to the backlight control area of the display screen, thereby reserving a corresponding display area on the display screen for the video demonstration image, while setting the grayscale data in the automatic color correction table in the automatic color correction circuit to the preset maximum grayscale value according to the preset demonstration sample file, the timing control drive in the timing control circuit is used to set the effective coordinates of the video demonstration image in the preset template register according to the information of the non-backlight control area.

In some embodiments, the full-screen demonstration image is a spliced image of the video demonstration image located in the left half of the display screen and the white demonstration image located in the right half of the display screen.

If the television uses a direct backlight, the non-backlight control area is the area of the backlight array directly behind the left half of the display screen, and the backlight control area of the backlight array is the area of the backlight array directly behind the right half of the display screen.

Accordingly, the effective coordinates of the video demonstration image in the template register are set so that the video demonstration image in the full-screen demonstration image is displayed in the left half of the display screen, and the white demonstration image in the full-screen demonstration image is displayed in the right half of the display screen.

The effective coordinates of the video demonstration image in the template register can be set based on the parameters of the display screen. For example, for a display screen with a resolution of 2160*2160, the effective coordinates of the video demonstration image in the template register are set to (1080, 2160), so that the left half of the display screen displays the normal video demonstration image and the right half of the display screen displays the white demonstration image.

The timing control circuit in the system-on-chip of the television is a commonly used circuit in the system-on-chip of the television. Therefore, by utilizing the timing control circuit in the system-on-chip of the television to generate corresponding demonstration drive data based on the first backlight demonstration notification and drive the display screen to display the corresponding full-screen demonstration image based on the demonstration drive data, these steps help to improve the compatibility of the method for performing a backlight demonstration on a television in the embodiments of the present disclosure, and eliminate dedicated hardware for backlight demonstration in the television, which is conducive to reducing the cost of backlight demonstration on a television.

Referring to FIG. 2, step S240 is performed to utilize the timing control circuit in the system-on-chip of the television to send a second backlight demonstration notification.

Utilizing the timing control circuit in the system-on-chip of the television to send a second backlight demonstration notification provides a basis for subsequently utilizing the local dimming circuit to generate corresponding first backlight control data based on the full-screen demonstration image upon receiving the second backlight demonstration notification.

In some embodiments, the television's video signal and backlight signal are two different signals. Accordingly, after the timing control circuit drives the display screen to display a corresponding full-screen demonstration image, the timing control circuit sends a second backlight demonstration notification to the local dimming circuit, so that upon receiving the second backlight demonstration notification, the local dimming circuit generates corresponding first backlight control data based on the full-screen demonstration image.

In some embodiments, the second backlight demonstration notification is a flag command. Regarding the flag command, please refer to the corresponding content in the aforementioned first backlight demonstration notification and will not be further described.

Continuing with reference to FIG. 2, step S250 is performed to utilize the local dimming circuit to generate corresponding first backlight control data based on the full-screen demonstration image upon receiving the second backlight demonstration notification.

Utilizing the local dimming circuit to generate corresponding first backlight control data based on the full-screen demonstration image upon receiving the second backlight demonstration notification provides a basis for subsequently utilizing the backlight control chip to control the backlight array of the television based on the first backlight control data.

In some embodiments, the step of utilizing the local dimming circuit to generate corresponding first backlight control data based on the full-screen demonstration image includes: acquiring local dimming data for a non-backlight control area of the backlight array, wherein the local dimming data for the non-backlight control area of the backlight array is the local dimming data for the video demonstration image; mapping the local dimming data for the non-backlight control area of the backlight array to a backlight control area of the backlight array according to a preset mapping relationship to acquire the local dimming data for the backlight control area of the backlight array; and setting the local dimming data for the non-backlight control area of the backlight array to a preset maximum dimming value, after mapping the local dimming data for the non-backlight control area of the backlight array to the backlight control area of the backlight array according to the preset mapping relationship; wherein the local dimming data for the non-backlight control area of the backlight array and the local dimming data for the backlight control area of the backlight array are both the maximum dimming value, constituting the first backlight control data.

In some embodiments, the full-screen demonstration image is a spliced image of the video demonstration image located in the left half area of the display screen and the white demonstration image located in the right half area of the display screen. If the television uses a direct backlight, the local dimming data of the non-backlight control area is the local dimming data of the backlight located directly behind the left half area of the display screen, and the backlight control area of the backlight array is the local dimming data of the backlight located directly behind the right half area of the display screen.

Correspondingly, the step of mapping the local dimming data for the non-backlight control area of the backlight array to a backlight control area of the backlight array according to a preset mapping relationship to acquire the local dimming data for the backlight control area of the backlight array includes: using the local dimming data of the backlight in the non-backlight control area as the local dimming data of the backlight in the symmetrical position in the backlight control area.

With reference to FIG. 3, for example, the backlight array of the television includes 3*6 backlights. The backlights in the non-backlight control area of the backlight array include \textcircled{1}, \textcircled{2}, \textcircled{3}, \textcircled{7}, \textcircled{8}, \textcircled{9}, \textcircled{13}, \textcircled{14}, and \textcircled{15}, and the backlights in the backlight control area include \textcircled{4}, \textcircled{5}, \textcircled{6}, \textcircled{10}, \textcircled{11}, \textcircled{12}, \textcircled{16}, \textcircled{17}, and \textcircled{18}. Backlight \textcircled{1} is symmetrical with backlight \textcircled{6}, backlight \textcircled{2} is symmetrical with backlight \textcircled{5}, . . . , and backlight \textcircled{13} is symmetrical with backlight \textcircled{18}. Accordingly, the local dimming data of backlight \textcircled{1} is used as the local dimming data of backlight \textcircled{6}, the local dimming data of backlight \textcircled{2} is used as the local dimming data of backlight \textcircled{5}, . . . , and the local dimming data of backlight \textcircled{13} is used as the local dimming data of backlight \textcircled{18}.

After mapping the local dimming data of the non-backlight control areas of the backlight array to the backlight control areas of the backlight array according to a preset mapping relationship, the local dimming data of the non-backlight control areas of the backlight array are set to a preset maximum dimming value, so that the backlight brightness of the non-backlight control areas of the backlight array reaches maximum.

After receiving the second backlight demonstration notification, the method for performing a backlight demonstration on a television further includes: returning a corresponding first return value to the user interface through a television server process and a television client process using the local dimming circuit, wherein the first return value is used to indicate that the backlight demonstration instruction is successfully issued.

After receiving the second backlight demonstration notification, the local dimming circuit is used to return the corresponding first return value to the user interface through the TV server process and the TV client process in sequence, so that the user interface can acquire the information that the backlight demonstration instruction is successfully issued, so that the timing control circuit and the local dimming circuit can respectively control the display screen and the backlight array to perform the backlight demonstration operation.

Continuing with reference to FIG. 2, step S260 is performed to utilize the backlight control chip to control the backlight array of the television based on the first backlight control data.

In some embodiments, utilizing the backlight control chip to control the backlight array of the television based on the first backlight control data means utilizing the backlight control chip to control the backlights in the backlight array to illuminate the display screen with corresponding brightness based on the first backlight control data.

A backlight control chip is used to control the backlight array of the television based on first backlight control data, that is, the backlight control chip is used, based on the first backlight

control data, to control the backlights in non-backlight control areas of the backlight array to illuminate at maximum brightness and to control the backlight control areas of the backlight array to display the backlight brightness corresponding to the video demonstration image displayed on the display screen, thereby allowing a user to intuitively feel the backlight performance of the television through comparison.

In some embodiments, the local dimming circuit and the backlight control chip communicate via a serial peripheral interface (SPI). Accordingly, the backlight control chip receives the first backlight control data transmitted by the local dimming circuit via the SPI.

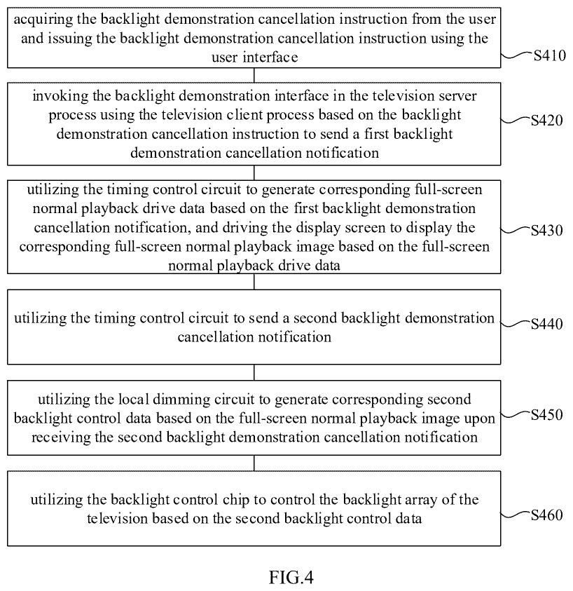

In some embodiments, when the television is performing a backlight demonstration operation, it can also switch from the backlight demonstration state to the normal play state according to a backlight demonstration cancellation instruction from the user. Specifically, referring to FIG. 4, the method for performing a backlight demonstration on a television further includes:

Step S410: acquiring the backlight demonstration cancellation instruction from the user and issuing the backlight demonstration cancellation instruction using the user interface;

Step S420: invoking the backlight demonstration interface in the television server process using the television client process based on the backlight demonstration cancellation instruction to send a first backlight demonstration cancellation notification;

Step S430: utilizing the timing control circuit to generate corresponding full-screen normal playback drive data based on the first backlight demonstration cancellation notification, and driving the display screen to display the corresponding full-screen normal playback image based on the full-screen normal playback drive data;

Step S440: utilizing the timing control circuit to send a second backlight demonstration cancellation notification;

Step 450: utilizing the local dimming circuit to generate corresponding second backlight control data based on the full-screen normal playback image upon receiving the second backlight demonstration cancellation notification;

Step 460: utilizing the backlight control chip to control the backlight array of the television based on the second backlight control data.

In step S430, the timing control circuit is used to generate corresponding full-screen normal playback driving data according to the first backlight demonstration cancellation notification, and to drive the display screen to display the corresponding full-screen normal playback image according to the full-screen normal playback driving data, thereby switching the full-screen demonstration image displayed on the display screen to the full-screen normal playback image.

Correspondingly, utilizing the timing control circuit to generate corresponding full-screen normal playback drive data, and driving the display screen to display the corresponding full-screen normal playback image based on the full-screen normal playback drive data includes: refreshing the grayscale data in the automatic color correction table based on the full-screen normal playback image, so that the grayscale data in the automatic color correction table are corresponding grayscale values, and deleting the effective coordinates of the video demonstration image set in the preset template register; and driving the display screen to display the full-screen normal playback image based on the grayscale data in the automatic color correction table.

In some embodiments, the timing control driver in the timing control circuit is used to refresh the grayscale data in the automatic color correction table based on the full-screen normal playback image, so that the grayscale data in the automatic color correction table are corresponding grayscale values, and the effective coordinates of the video demonstration image set in the preset template register are deleted.

The timing control driver in the timing control circuit is used to refresh the grayscale data in the automatic color correction table based on the full-screen normal playback image, so that the grayscale data in the automatic color correction table are corresponding grayscale values, that is, the grayscale data in the automatic color correction table are grayscale data corresponding to the full-screen normal playback image.

At the same time, the effective coordinates of the video demonstration image set in the preset template register are deleted, allowing the video signal to be displayed full-screen on the display screen.

In step S450, when the local dimming circuit acquires the second backlight demonstration cancellation notification, it generates corresponding second backlight control data according to the full-screen normal playback image, so that the backlight brightness of the backlights in the backlight array is adapted to the full-screen normal playback image.

In some embodiments, utilizing the local dimming circuit to generate corresponding second backlight control data based on the full-screen normal playback image comprises: setting the local dimming data of the backlight array to corresponding dimming values based on the full-screen normal playback image using the local dimming circuit.

After receiving the second backlight demonstration cancellation notification, the method for performing a backlight demonstration on a television further comprising: returning a corresponding second return value to the user interface through the television server process and the television client process using the local dimming circuit, wherein the second return value is used to indicate that the backlight demonstration cancellation instruction is successfully issued.

After acquiring the second backlight demonstration cancellation notification, the local dimming circuit is used to return the corresponding second return value to the user interface through the TV server process and the TV client process in sequence, so that the user interface can acquire the information that the backlight demonstration cancellation instruction is successfully issued, so that the timing control circuit and the local dimming circuit can respectively control the display screen and the backlight array to perform normal video image playback operations.

For steps S410, S420, S440, and S460, refer to the aforementioned steps S210, S220, S240, and S260, respectively, and will not be repeated here.

Accordingly, a device for performing a backlight demonstration on a television is provided in the embodiments of the present disclosure.

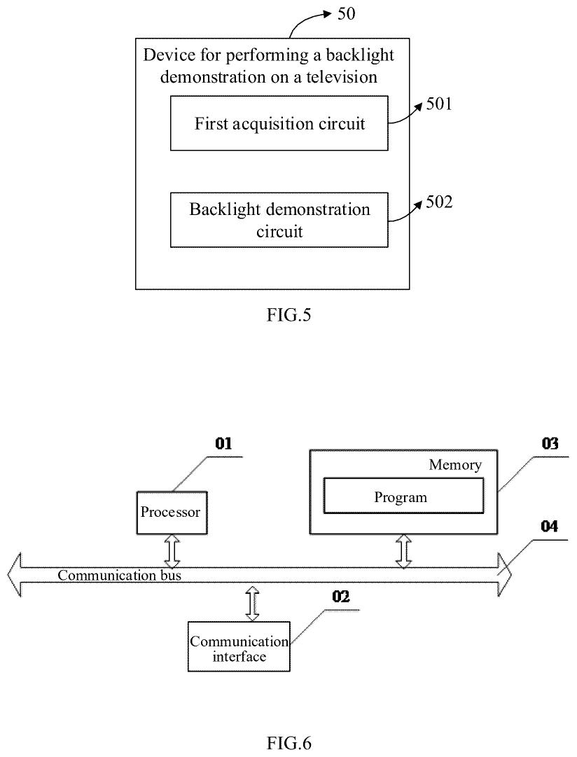

FIG. 5 shows a schematic structural diagram of an embodiment of device for performing a backlight demonstration on a television according to the present disclosure. With reference to FIG. 5, a device 50 for performing a backlight demonstration on a television may include: a first acquisition circuit 501 (which may be a programmable module implemented by at least one processor), configured to acquire a backlight demonstration instruction from a user; and a backlight demonstration circuit 502 (which may be a programmable module implemented by at least one processor), configured to utilize a timing control circuit and a local dimming circuit in a system-on-chip of a television to generate corresponding backlight demonstration control data to control a display screen and a backlight array of the television to perform the backlight demonstration, when the backlight demonstration instruction from the user is acquired.

The device for performing a backlight demonstration on a television provided in the embodiments of the present disclosure can be used to execute the aforementioned method for performing a backlight demonstration on a television, or it may utilize other functional modules to execute the aforementioned method for performing a backlight demonstration on a television. For a detailed description of the method for performing a backlight demonstration on a television, please refer to the aforementioned section, and will not be repeated here.

Accordingly, a device is provided in the embodiments of the present disclosure. The device can implement the method for performing a backlight demonstration on a television provided by the embodiments of the present disclosure by loading the aforementioned method for performing a backlight demonstration on a television in program form.

FIG. 6 shows a schematic structural diagram of an optional hardware of the device according to the present disclosure. The device includes: at least one processor 01, at least one communication interface 02, at least one memory 03, and at least one communication bus 04.

In some embodiments, the number of each of the processor 01, the communication interface 02, the memory 03 and the communication bus 04 is at least one, and the processor 01, the communication interface 02 and the memory 03 communicate with each other via the communication bus 04.

Communication interface 02 can be an interface of a communication module for network communication, such as an interface of a GSM module.

Processor 01 can be a central processing unit (CPU), an application-specific integrated circuit (ASIC), or one or more integrated circuits configured to implement the television backlight demonstration method of this embodiment.

Memory 03 may include high-speed RAM memory or non-volatile memory, such as at least one disk drive. Memory 03 stores one or more computer instructions, which are executed by processor 01 to implement the television backlight demonstration method provided in the aforementioned embodiment.

It should be noted that the electronic device described above may also include other components (not shown) that may not be essential to the disclosure of the embodiments of the present disclosure. Since these other components may not be essential for understanding the disclosure of the embodiments of the present disclosure, the embodiments of the present disclosure do not describe them one by one.

Accordingly, a computer program product is further provided in the embodiments of the present disclosure, comprising a computer program/instruction, wherein when executed by a processor, the computer program/instruction implements any one of the methods for performing a backlight demonstration on a television above.

A storage medium is further provided in the embodiments of the present disclosure, having one or more computer instructions stored thereon, wherein the one or more computer instructions are used to implement any one of the methods for performing a backlight demonstration on a television above.

The aforementioned embodiments of the present disclosure are combinations of elements and features of the present disclosure. Unless otherwise noted, an element or feature may be considered optional. Each element or feature may be practiced without being combined with other elements or features. Furthermore, embodiments of the present disclosure may be constructed by combining some elements and/or features. The order of operations described in embodiments of the present disclosure may be rearranged. Some features of any embodiment may be included in another embodiment and replaced with corresponding features of another embodiment. It will be apparent to those skilled in the art that claims that do not explicitly reference each other in the appended claims may be combined to form embodiments of the present disclosure, or may be included as new claims in amendments made after the filing of this application.

Embodiments of the present disclosure may be implemented through various means, such as hardware, firmware, software, or a combination thereof. In hardware configurations, the methods according to exemplary embodiments of the present disclosure may be implemented through one or more application-specific integrated circuits (ASICs), digital signal processors (DSPs), digital signal processing devices (DSPDs), programmable logic devices (PLDs), field-programmable gate arrays (FPGAs), processors, controllers, microcontrollers, microprocessors, and the like.

In firmware or software configurations, embodiments of the present disclosure may be implemented in the form of modules, procedures, functions, and the like. Software code may be stored in a memory unit and executed by a processor. The memory unit may be located internally or externally to the processor and may transmit and receive data to and from the processor via various known means.

The above description of the disclosed embodiments enables those skilled in the art to implement or use the present disclosure. Various modifications to these embodiments will be apparent to those skilled in the art, and the general principles defined herein may be implemented in other embodiments without departing from the spirit or scope of the present disclosure. Thus, the present disclosure will not be limited to the embodiments shown herein but will be accorded the widest scope consistent with the principles and novel features disclosed herein.

Although disclosed as above, the present disclosure is not limited to the foregoing description. A person skilled in the art can make various changes and modifications without departing from the spirit and the scope of the present disclosure. Thus, the scope of protection of the present disclosure should be subject to the scope defined by the claims.

1. A method for performing a backlight demonstration on a television, comprising:
acquiring a backlight demonstration instruction from a user; and
utilizing a timing control circuit and a local dimming circuit in a system-on-chip of a television to generate corresponding backlight demonstration control data to control a display screen and a backlight array of the television to perform the backlight demonstration, when the backlight demonstration instruction from the user is acquired.

2. The method for performing a backlight demonstration on a television according to claim 1, wherein utilizing the timing control circuit and the local dimming circuit in the system-on-chip of the television to generate corresponding backlight demonstration control data to control the display screen and the backlight array of the television to perform the backlight demonstration comprises:
utilizing the timing control circuit to generate corresponding demonstration drive data, and driving the display screen to display a corresponding full-screen demonstration image based on the demonstration drive data;
utilizing the local dimming circuit to generate corresponding first backlight control data based on the full-screen demonstration image, when the full-screen demonstration image is displayed on the display screen; and
utilizing a backlight control chip to control the backlight array of the television based on the first backlight control data.

3. The method for performing a backlight demonstration on a television according to claim 2, wherein the full-screen demonstration image is a spliced image of a video demonstration image located in a non-backlight control area of the display screen and a white demonstration image located in a backlight control area of the display screen.

4. The method for performing a backlight demonstration on a television according to claim 3, wherein utilizing the timing control circuit to generate corresponding demonstration drive data, and driving the display screen to display the corresponding full-screen demonstration image based on the demonstration drive data comprises:
setting grayscale data in an automatic color correction table to corresponding maximum grayscale values based on a preset demonstration template file;
setting effective coordinates of the video demonstration image in a preset template register based on information of the non-backlight control area; and
driving the display screen to display the full-screen demonstration image based on the grayscale data in the automatic color correction table and the effective coordinates of the video demonstration image in the template register.

5. The method for performing a backlight demonstration on a television according to claim 3, wherein utilizing the local dimming circuit to generate corresponding first backlight control data based on the full-screen demonstration image comprises:
acquiring local dimming data for a non-backlight control area of the backlight array, wherein the local dimming data for the non-backlight control area of the backlight array is the local dimming data for the video demonstration image;
mapping the local dimming data for the non-backlight control area of the backlight array to a backlight control area of the backlight array according to a preset mapping relationship to acquire the local dimming data for the backlight control area of the backlight array; and
setting the local dimming data for the non-backlight control area of the backlight array to a preset maximum dimming value, after mapping the local dimming data for the non-backlight control area of the backlight array to the backlight control area of the backlight array according to the preset mapping relationship;
wherein the local dimming data for the non-backlight control area of the backlight array and the local dimming data for the backlight control area of the backlight array are both the maximum dimming value, constituting the first backlight control data.

6. The method for performing a backlight demonstration on a television according to claim 2, wherein the local dimming circuit uses a preset serial peripheral interface to transmit the first backlight control data to the backlight control chip, so that the backlight control chip controls the backlight array of the television according to the first backlight control data.

7. The method for performing a backlight demonstration on a television according to claim 2, wherein acquiring the backlight demonstration instruction from the user comprises: acquiring the backlight demonstration instruction from the user using a preset user interface;
after acquiring the backlight demonstration instruction from the user, and before utilizing the timing control circuit to generate corresponding demonstration drive data, and driving the display screen to display the corresponding full-screen demonstration image based on the demonstration drive data, further comprising: issuing the backlight demonstration instruction using the user interface; and invoking a backlight demonstration interface in a television server process using a television client process based on the backlight demonstration instruction to send a first backlight demonstration notification, causing the timing control circuit to generate corresponding demonstration drive data based on the first backlight demonstration notification, and driving the display screen to display the corresponding full-screen demonstration image based on the demonstration drive data;
after utilizing the timing control circuit to generate corresponding demonstration drive data, and driving the display screen to display the corresponding full-screen demonstration image based on the demonstration drive data, and before utilizing the local dimming circuit to generate corresponding first backlight control data based on the full-screen demonstration image, further comprising: sending a second backlight demonstration notification to the local dimming circuit using the timing control circuit, causing the local dimming circuit to generate corresponding first backlight control data based on the full-screen demonstration image upon receiving the second backlight demonstration notification; and
after receiving the second backlight demonstration notification, further comprising: returning a corresponding first return value to the user interface through a television server process and a television client process using the local dimming circuit, wherein the first return value is used to indicate that the backlight demonstration instruction is successfully issued.

8. The method for performing a backlight demonstration on a television according to claim 1, further comprising:
acquiring a backlight demonstration cancellation instruction from the user; and
utilizing the timing control circuit and the local dimming circuit to generate corresponding normal playback drive data to control the display screen and the backlight array of the television for normal playback, when the backlight demonstration cancel instruction from the user is acquired.

9. The method for performing a backlight demonstration on a television according to claim 8, wherein utilizing the timing control circuit and the local dimming circuit to generate corresponding normal playback drive data to control the display screen and the backlight array of the television for normal playback comprises:
utilizing the timing control circuit to generate corresponding full-screen normal playback drive data, and driving the display screen to display the corresponding full-screen normal playback image based on the full-screen normal playback drive data;
utilizing the local dimming circuit to generate corresponding second backlight control data based on the full-screen normal playback image, when the full-screen normal playback image is displayed on the display screen; and
utilizing the backlight control chip to control the backlight array of the television based on the second backlight control data.

10. The method for performing a backlight demonstration on a television according to claim 9, wherein utilizing the timing control circuit to generate corresponding full-screen normal playback drive data, and driving the display screen to display the corresponding full-screen normal playback image based on the full-screen normal playback drive data comprises:
refreshing the grayscale data in the automatic color correction table based on the full-screen normal playback image, so that the grayscale data in the automatic color correction table are corresponding grayscale values, and deleting the effective coordinates of the video demonstration image set in the preset template register; and
driving the display screen to display the full-screen normal playback image based on the grayscale data in the automatic color correction table.

11. The method for performing a backlight demonstration on a television according to claim 9, wherein utilizing the local dimming circuit to generate corresponding second backlight control data based on the full-screen normal playback image comprises:
setting the local dimming data of the backlight array to corresponding dimming values based on the full-screen normal playback image using the local dimming circuit.

12. The method for performing a backlight demonstration on a television according to claim 9, wherein acquiring the backlight demonstration cancellation instruction from the user comprises: acquiring the backlight demonstration cancellation instruction from the user using the preset user interface;
after acquiring the backlight demonstration cancellation instruction from the user, and before utilizing the timing control circuit to generate corresponding full-screen normal playback drive data, and driving the display screen to display the corresponding full-screen normal playback image based on the full-screen normal playback drive data, further comprising: issuing the backlight demonstration cancellation instruction using the user interface; and invoking the backlight demonstration interface in the television server process using the television client process based on the backlight demonstration cancellation instruction to send a first backlight demonstration cancellation notification, causing the timing control circuit to generate corresponding full-screen normal playback drive data based on the first backlight demonstration cancellation notification, and driving the display screen to display the corresponding full-screen normal playback image based on the full-screen normal playback drive data;
after utilizing the timing control circuit to generate corresponding full-screen normal playback drive data, and driving the display screen to display the corresponding full-screen normal playback image based on the full-screen normal playback drive data, and before utilizing the local dimming circuit to generate corresponding second backlight control data based on the full-screen normal playback image, further comprising: sending a second backlight demonstration cancellation notification to the local dimming circuit using the timing control circuit, causing the local dimming circuit to generate corresponding second backlight control data based on the full-screen normal playback image upon receiving the second backlight demonstration cancellation notification; and
after receiving the second backlight demonstration cancellation notification, further comprising: returning a corresponding second return value to the user interface through the television server process and the television client process using the local dimming circuit, wherein the second return value is used to indicate that the backlight demonstration cancellation instruction is successfully issued.

13. A device for performing a backlight demonstration on a television, comprising:
at least one processor configured to:
acquire a backlight demonstration instruction from a user; and
utilize a timing control circuit and a local dimming circuit in a system-on-chip of a television to generate corresponding backlight demonstration control data to control a display screen and a backlight array of the television to perform the backlight demonstration, when the backlight demonstration instruction from the user is acquired.

14. A device, comprising at least one memory and at least one processor, wherein the at least one memory stores one or more computer instructions that, when executed by the at least one processor, cause the at least one processor to implement a method for performing a backlight demonstration on a television, wherein the method comprises:
acquiring a backlight demonstration instruction from a user; and
utilizing a timing control circuit and a local dimming circuit in a system-on-chip of a television to generate corresponding backlight demonstration control data to control a display screen and a backlight array of the television to perform the backlight demonstration, when the backlight demonstration instruction from the user is acquired.

15. The device according to claim 14, wherein utilizing the timing control circuit and the local dimming circuit in the system-on-chip of the television to generate corresponding backlight demonstration control data to control the display screen and the backlight array of the television to perform the backlight demonstration comprises:
utilizing the timing control circuit to generate corresponding demonstration drive data, and driving the display screen to display a corresponding full-screen demonstration image based on the demonstration drive data;
utilizing the local dimming circuit to generate corresponding first backlight control data based on the full-screen demonstration image, when the full-screen demonstration image is displayed on the display screen; and
utilizing a backlight control chip to control the backlight array of the television based on the first backlight control data.

16. The device according to claim 15, wherein the full-screen demonstration image is a spliced image of a video demonstration image located in a non-backlight control area of the display screen and a white demonstration image located in a backlight control area of the display screen.

17. The device according to claim 16, wherein utilizing the timing control circuit to generate corresponding demonstration drive data, and driving the display screen to display the corresponding full-screen demonstration image based on the demonstration drive data comprises:
setting grayscale data in an automatic color correction table to corresponding maximum grayscale values based on a preset demonstration template file;
setting effective coordinates of the video demonstration image in a preset template register based on information of the non-backlight control area; and
driving the display screen to display the full-screen demonstration image based on the grayscale data in the automatic color correction table and the effective coordinates of the video demonstration image in the template register.

18. The device according to claim 16, wherein utilizing the local dimming circuit to generate corresponding first backlight control data based on the full-screen demonstration image comprises:
acquiring local dimming data for a non-backlight control area of the backlight array, wherein the local dimming data for the non-backlight control area of the backlight array is the local dimming data for the video demonstration image;
mapping the local dimming data for the non-backlight control area of the backlight array to a backlight control area of the backlight array according to a preset mapping relationship to acquire the local dimming data for the backlight control area of the backlight array; and
setting the local dimming data for the non-backlight control area of the backlight array to a preset maximum dimming value, after mapping the local dimming data for the non-backlight control area of the backlight array to the backlight control area of the backlight array according to the preset mapping relationship;
wherein the local dimming data for the non-backlight control area of the backlight array and the local dimming data for the backlight control area of the backlight array are both the maximum dimming value, constituting the first backlight control data.

19. The device according to claim 15, wherein the local dimming circuit uses a preset serial peripheral interface to transmit the first backlight control data to the backlight control chip, so that the backlight control chip controls the backlight array of the television according to the first backlight control data.

20. The device according to claim 15, wherein acquiring the backlight demonstration instruction from the user comprises: acquiring the backlight demonstration instruction from the user using a preset user interface;
after acquiring the backlight demonstration instruction from the user, and before utilizing the timing control circuit to generate corresponding demonstration drive data, and driving the display screen to display the corresponding full-screen demonstration image based on the demonstration drive data, further comprising: issuing the backlight demonstration instruction using the user interface; and invoking a backlight demonstration interface in a television server process using a television client process based on the backlight demonstration instruction to send a first backlight demonstration notification, causing the timing control circuit to generate corresponding demonstration drive data based on the first backlight demonstration notification, and driving the display screen to display the corresponding full-screen demonstration image based on the demonstration drive data;
after utilizing the timing control circuit to generate corresponding demonstration drive data, and driving the display screen to display the corresponding full-screen demonstration image based on the demonstration drive data, and before utilizing the local dimming circuit to generate corresponding first backlight control data based on the full-screen demonstration image, further comprising: sending a second backlight demonstration notification to the local dimming circuit using the timing control circuit, causing the local dimming circuit to generate corresponding first backlight control data based on the full-screen demonstration image upon receiving the second backlight demonstration notification; and
after receiving the second backlight demonstration notification, further comprising: returning a corresponding first return value to the user interface through a television server process and a television client process using the local dimming circuit, wherein the first return value is used to indicate that the backlight demonstration instruction is successfully issued.
